(19) United States
(12) Patent Application Publication
(10) Pub. No.: US 2004/0149825 A1
(43) Pub. Date: Aug. 5, 2004

(54) Votemaster system: a system conduct an election

(76) Inventor: Montague D. Griffin, San Diego, CA (US)

Correspondence Address: Montague D. Griffin, 2034 Upas St., San Diego, CA, 92104-4045, US

(21) Appl. No.: 10/353,252

(22) Filed: Jan. 30, 2003

(51) Int. Cl. G06F 17/60

(52) U.S. Cl. 235/386

(57) ABSTRACT

This invention advanced “State Art” in American elections in that it design a plan conduct an election. The design plan is System approach.

It compass phases of operation the election. These are: the mechanic conduct an election; ballot form; the cast ballots; the precint voting procedure at precints; read and tally ballots; trasmit the tally to Registrar; assemble tallys (from precints), at Registrar; integate communication of Registrar and precints by wireless WAN (end-to-end encryption, full duplex link); time elapse of runing the election.

These objectives by application current combination of technology—radio wireless WAN transmission; database mangment; system approarch.

### FEDERALLY SPONSORED REARCH/DEVELOMENT

(n. a.)

### BACKGROUND OF THE INVENTION

The typical American election is hodgepodge, just grew up numous years; hold an election in States it generate many controversy and disputes turning the courses of the nation. This situation calls design plan ie. conduct of the American election with logic, accurate, design.

### BRIEF SUMMARY OF THE INVENTION

My intent this invention is to elimination many problens in American elections, by a design unform system for conducting an election everywhere;

by to improve and simplify ballots; to method of cast the ballot, to method of tally the ballots; to method of collect ballots from widespread precints; to cut elapse time for process election on the day of election.

My invention fulfill these objections by design “system principles”, rely current techology—IR scanners, barcode, wireless LAN, displays LEDs.

### DETAILED DESCRIPTION OF THE INVENTION

My invention is a system conduct an election AMERICAN election. ALL elements-real-time “tallyvotes” of ballots; design logical ballots; design voteing procedure; election-reporting; efficient; accurate scanning of ballots and

incorporate the System these Design Pinciples:

1. All Americans due one vote.

2. Ballots—simplify, clear, logical.

3. Conducting of elections is equability, efficient, fast, ecomomic.

4. Reliable, accurate, fast count of ballots.

5. Votemaster employ curent technics:

a. optic scanning of bar code.

b. database mangement of election data.

c. data-communication concepts.

d. design to “System” concept.

e. secure the election by encryption VMNET (vi.) transmission election data.

The Votemaster System comprise TWO components:

ONE, Votemaster Center at Registrar consist of

Votemaster Wireless WAN modem, whose origin of net (VMNET); the general purpose computer (GP) cluster; whose function are:

1. Control the System.

2. Control the VMNET.

3. Control election data transmission stream through VMNET.

4. Interface Registrar.

5. Cyclic interrogate via VMNET various VMRM (vi.)

6. Verify the election data received, from VMRMs.

6. Cyclic interrogate via VMNET various VMRMs “ask” their messages “tallyvotes”.

7. compile receive VMRMs “tallyvotes”, form (realtime) results of election status report to Registrar.

TWO, VOTEMASTER has Remote Mobile (VMRM)

VMRMs are consolidation of the groups of precints.

The precints number, likely 5000, for populous county.

These VMRMs contain 200-500 voters.

The concept of VMRMs are these:

1. Communty consolidate precints.

2. Hightly recognize.

3. Voter convenenient.

4. Efficent for an election, accommodate 500 voters.

5. Mobile (flexible).

6. Definite location.

7. Internet site.

The VMRMs units vital to rapid conduce the election.

The VMRMs has number (PN) that assign Restrar designate consolidation precints to assign specfic election by fixed location (street addess, community center, cross street, GPS coodinates).

The VMRMs are self-contain trailer-mounted.

It is equip with power generation unit, climate control, lighting, voter's comfort station, flagpole, and American flag, GPS unit.

The Trailer layout is: partition of 9 compartments; the hall runs to end-to end; one end, is entrance door, with stairs, handrail both sides;

exit, other end, identical entrance.

The Trailer internal layout: entrance is door into large room “Ready-Room”; furnish of long table, behind swivel chairs (precint staff), against room wall three fixed chairs (voters wait to vote).

Along hall, six partition (voter's “booths”); farther back, the VMRM data-process room; farther back, a voter's comfort station (conceptual an airliner commode).

Trailer both sides are painted with red letters—“ELECTION PRECINT”, following the VMRM (PN), this, backgroun blue.

The Trailer's both sides are hinged recess panels, therein voter's information: sample ballot, procedure to vote, picture of how voters held the scanner (vi.) when voteing.

Voter's booths are closed door on booth's, (id); on door sensor: sense door is open/close.

Inside, built-in “vote table” pattern of “vanity table”; well lighted, rigid, flat, table, (to scan ballot), keypad, under table space (for the legs), a chair, with wheels; faceing voter eye-level-display array (replace mirror) of LED (light-emit diodes red/green) and display window, alfa-numerical which display voters see his scan; whence voter check his scan, if voter judge has make error, then press “repeat scan” button on keypad;

ballot (“Booklet”), one language (voter choice).

The ballots are printed in language, options of Registrar, and barcode hand-held IR-scanner to scan booklet; (scanner number (id.) match to booth's number. To facilitate voter waiting, the booth (id) is “vacant”.

There is “booth number open” sign above hall entrance, and audio system drive a speaker mounting in Ready-Room

alert waiting voters (corresponding sign) and voice “Booth Open”.

In the data-process room, there is a cluster compatible to the unit at VM Center. This cluster equip System Console (terminal: keyboad, screen, printer);

disk drive with removable disks;

VMNET modem, GPS unit, audio system, Cluster Controller.

VM-Ballots design is logical, based concept of linear algebra; consist 3 blocks/fields/lines of barcode (categories of voter' choice). This blocking apply to national election; 3 block are offices; first block is national offices; second block is state offices; third block is local offices; (examples are county, city, school). Voter choices (lines) are: candidates, propsitions, bonds, broards, directors, counsils, supervisors, etcetera. Field are candidates of offices. Ballots is highly organizer. Voters present simple, clear, unamiguous ballots.

A Votemaster Ballot is record, consisting of sequence-numbers (lines of bar-codes of voter's choice). Site (VMRM) computer interface booths's scanner and VMNET modem, “tally” these records, by real-time to sequence interrogate 1-6 booths. The VMRM “vote” is file of records

The VMRM's file store in removable disk drive. (to verify file's data); to encode the file, and VMRM's PN, date-time, in a VMRMM (message), when Votemaster Center at registrar cyclic interrogate via VMNET (“ask” this message), and reply via VMNET.

The Votemaster ballot is subtitute printed bar-code pages for mechical postion punch cards.

Pysical structure for ballots is booklet, ring-binding, lying flat; the pages made out white cardstock printed the “ballot”; the voters chose line, scan line; scaner reads barcode and site computer interrogate sequence booths (“handshake mode”); store results plus IDs. booth/precint.

What I claim as invention is:

1. A SYSYTEM, VOTEMASTER (“VM”) to conduct American Elecctions for any politcal division in United States, all it's possessions.

2. That integrate the Registrar and it's farflung precints by data-communication beteen Registrar and precints.

3. That install wireless Wide Area Network (WAN) or (“VMNET”) VMNET encompass the Registrar and it's precints.

4. VOTEMASTER at VMRMs (vi) read and tally VM-ballots collect and send to Registrar in Real-time.

5. VOTEMASTER is parition two active parts—one at the Registrar, two at precints.

6. At Registrar, there is installation (VM-Center); it's equipments and ftmtion are: (a) computation system, (b) wireless WAN modem; (c) commmand and control the VOTEMASTER, (d) control VMNET, (e) interface Registrar, (f) accumlate “tallyvotes” from precints, (g) store income election data from precints, (h) create real-time election result report for Registrar.

7. At VOTEMASTER Precint there is a self-contain trailer, “Remote Mobile” (VMRM) cluster of precints (200-5000 voters, include all of precints, likely 5000, big counties). The trailer is partition, of 9 compartments, one 9 is computer room which contents are: computation cluster, (compatible the computation system in VM-Center), Cluster Converer, wireless WAN modem, GPS receiver, audio system.

8. In the VMRM, 6 compartments are voter's “booths” which, contains: version of “vanity Table”, VM-Ballot, Hand-held IR-Barcode scanner, a voter's display.

9. The VM-Ballot design is logical, based concept of linear algebra; lines of barcodes consist 3 blocks/field/lines; first block is national offices; second block is state offices; third block is local offices: (examples are County, City, schools). Votes choices are: cadidates, bonds, propsitions, broards, directors, counsils, supervisors, etcetera. Fields are candidates of office; Lines are voter choices.

10. The VM-Ballot is record, consisting of sequence-numbers, lines verical barcodes.

11. The ballot physical structure is booklet, ring-binding, lying flat, the pages made out white cardstock, printing in barcode, Voters will chose line, scan line.

12. VM-ballot present votes logical, simple clear, unamiguous ballots.

13. The VM-ballot is alternation/substitute for printed barcode pages in mechical postion punch cards or touch screen.

14. VOTEMASTER collect in real-timer “tallyvotes” from all precints at Registrar.
